(19) United States
(12) Patent Application Publication
(10) Pub. No.: US 2018/0275874 A1
(43) Pub. Date: Sep. 27, 2018

(54) STORAGE SYSTEM AND PROCESSING METHOD

(71) Applicant: Toshiba Memory Corporation, Tokyo (JP)

(72) Inventors: Kenji TAKAHASHI, Kawasaki Kanagawa (JP); Yuki SASAKI, Yokohama Kanagawa (JP); Atsuhiro KINOSHITA, Kamakura Kanagawa (JP)

(21) Appl. No.: 15/690,252

(22) Filed: Aug. 29, 2017

(30) Foreign Application Priority Data
Mar. 21, 2017 (JP) 2017-054955

(51) Int. Cl. G06F 3/06

(52) U.S. Cl. CPC G06F 3/061; G06F 3/067; G06F 3/0655; G06F 3/0688

(57) ABSTRACT

A storage system includes a plurality of storage nodes, each including a local processor and one or more non-volatile memory devices, a first control node having a first processor and directly connected to a first storage node, a second control node having a second processor and directly connected to a second storage node. The local processor of a node controls access to the non-volatile memory devices of said node and processes read and write commands issued from the first and second processors that are targeted for said node. Each of the first and second processors is configured to issue read commands to any of the storage nodes, and issue write commands only to a group of storage nodes allocated thereto, such that none of the storage nodes can be targeted by both the first and second processors.

### CROSS-REFERENCE TO RELATED APPLICATION

This application is based upon and claims the benefit of priority from Japanese Patent Application No. 2017-054955, filed Mar. 21, 2017, the entire contents of which are incorporated herein by reference.

### FIELD

Embodiments described herein relate generally to a storage system and a processing method.

### BACKGROUND

With the spread of cloud computing, there is an increasing demand for a storage system that can store a large amount of data and can process data input and data output at a high speed. This trend has become stronger as interest in big data has been increasing. As one of storage systems capable of responding to such a demand, there is proposed a storage system in which a plurality of memory nodes are connected to each other.

In such a storage system, in which memory nodes are connected to each other, the performance of the entire storage system may be degraded when there is a competition of exclusive locks for the memory nodes, and the like, which may occur at the time of writing data.

### DESCRIPTION OF THE DRAWINGS

FIG. 1 is a diagram illustrating one example usage of a storage system according to a first embodiment.

FIG. 2 is a diagram illustrating one example configuration of the storage system according to the first embodiment.

FIG. 3 is a diagram illustrating one example configuration of a node module (NM) of the storage system according to the first embodiment.

FIG. 4 is a diagram illustrating one example allocation of the NM to a connection unit (CU) in the storage system according to the first embodiment.

FIG. 5 is a functional block diagram of the storage system according to the first embodiment.

FIG. 6 is a diagram illustrating one example of an NM list of the storage system according to the first embodiment.

FIG. 7 is a flowchart illustrating an operation sequence of the storage system according to the first embodiment.

FIG. 8 is a flowchart illustrating a detailed sequence of selection processing of a writing destination NM in step A2 of FIG. 7.

FIG. 9 is a diagram illustrating another example allocation of the NM to the CU in the storage system according to the first embodiment.

FIG. 10 is a diagram illustrating another example of the NM list of the storage system according to the first embodiment.

FIG. 11 is a first diagram for describing an outline of a storage system according to a second embodiment.

FIG. 12 is a second diagram for describing the outline of the storage system according to the second embodiment.

FIG. 13 is a diagram for describing an interface which the storage system according to the second embodiment provides in order to operate a database.

FIG. 14 is a first diagram for describing an operation of the storage system according to the second embodiment at the time of registering a record.

FIG. 15 is a second diagram for describing the operation of the storage system according to the second embodiment at the time of registering the record.

FIG. 16 is a diagram illustrating one example of a data storage format of the storage system on an NM according to the second embodiment.

FIG. 17 is a diagram illustrating one example of metadata of the storage system according to the second embodiment.

FIG. 18 is a diagram illustrating one example of chunk management information of the storage system according to the second embodiment.

FIG. 19 is a diagram illustrating one example of a chunk registration sequence list of the storage system according to the second embodiment.

FIG. 20 is a diagram for describing an operation of the NM at the time of searching a record in the storage system according to the second embodiment.

FIG. 21 is a functional block diagram of the storage system according to the second embodiment.

FIG. 22 is a flowchart illustrating an operation sequence of a table management unit of the CU at the time of creating a table in the storage system according to the second embodiment.

FIG. 23 is a flowchart illustrating an operation sequence of the table management unit of the CU at the time of dropping the table in the storage system according to the second embodiment.

FIG. 24 is a flowchart illustrating an operation sequence of a CU cache management unit of the CU at the time of registering the record in the storage system according to the second embodiment.

FIG. 25 is a flowchart illustrating an operation sequence of a search processing unit of the CU at the time of searching the record in the storage system according to the second embodiment.

FIG. 26 is a flowchart illustrating an operation sequence of a search executing unit of the NM at the time of searching the record in the storage system according to the second embodiment.

FIG. 27 is a flowchart illustrating an operation sequence of a chunk management unit of the NM at the time of writing a chunk in the storage system according to the second embodiment.

FIG. 28 is a flowchart illustrating an operation sequence of the chunk management unit of the NM at the time of dropping the table in the storage system according to the second embodiment.

### DETAILED DESCRIPTION

An embodiment provides a storage system and a processing method capable of enhancing access performance.

In general, according to an embodiment, a storage system includes a plurality of storage nodes, each including a local processor and one or more non-volatile memory devices, a first control node having a first processor and directly connected to a first storage node, a second control node having a second processor and directly connected to a second storage node. The local processor of a node controls access to the non-volatile memory devices of said node and processes read and write commands issued from the first and second processors that are targeted for said node. Each of the first and second processors is configured to issue read commands to any of the storage nodes, and issue write commands only to a group of storage nodes allocated thereto, such that none of the storage nodes can be targeted by both the first and second processors.

Hereinafter, embodiments will be described with reference to the accompanying drawings.

### First Embodiment

First, a first embodiment will be described.

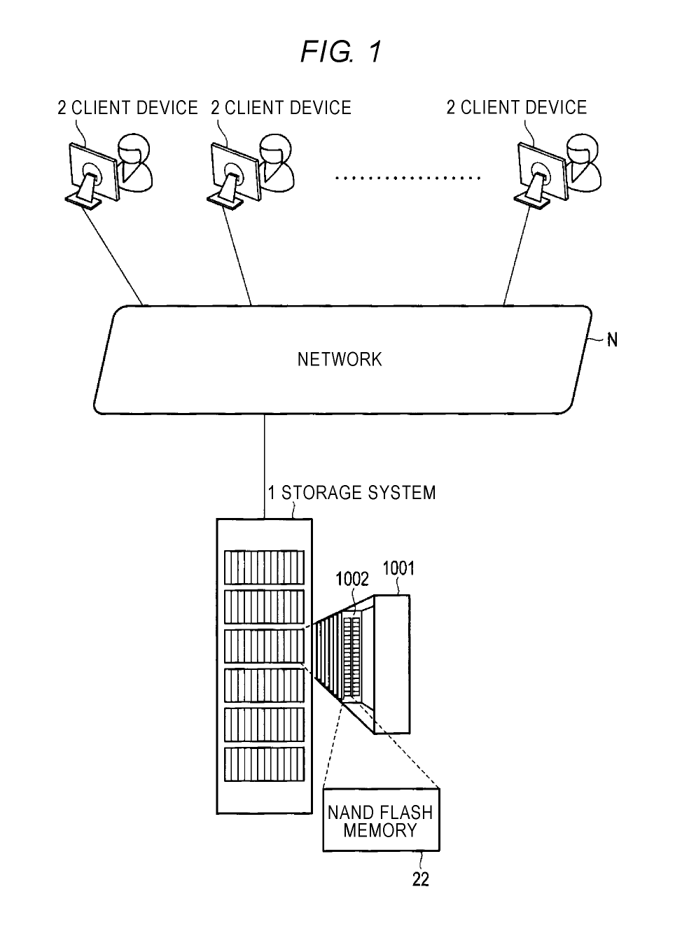

FIG. 1 is a diagram illustrating one example usage of a storage system 1 according to the embodiment.

The storage system 1 illustrated in FIG. 1 may be used as, for example, a file server that executes writing of data or reading of the data, and the like, according to requests from a plurality of client devices 2 connected via a network N. In one embodiment, the storage system 1 is implemented as a key value store (KVS) storage system called an object storage, and the like. In the storage system 1 which is the KVS type, a writing request of the data from the client device 2 includes written data (which corresponds to the “value”) and a “key” for identifying the written data. The storage system 1 that receives the request stores the key-value pair. Meanwhile, a reading request of the data from the client device 2 includes the key. As the key, for example, character strings including a file name and the like may be adopted. In other words, the client device 2 does not need to understand the logical or physicallayout of a data storage area of the storage system 1, such that determination of which data is written in a certain place of the data storage area of the storage system 1 is not required. Further, the storage system 1 may manage an index for obtaining a storage destination of the data from the key in a predetermined area of the data storage area.

A plurality of slots may be formed, for example, on a front surface of a case of the storage system 1 and a blade unit 1001 may be stored in each slot. Further, a plurality of board units 1002 may be contained in each blade unit 1001. A plurality of NAND flash memories 22 is mounted on each board unit 1002. The NAND flash memories 22 in the storage system 1 are connected in a matrix configuration through connectors of the blade unit 1001 and the board unit 1002. The NAND flash memories 22 are connected in a matrix configuration, and as a result, the storage system 1 is able to provide a high-capacity data storage area.

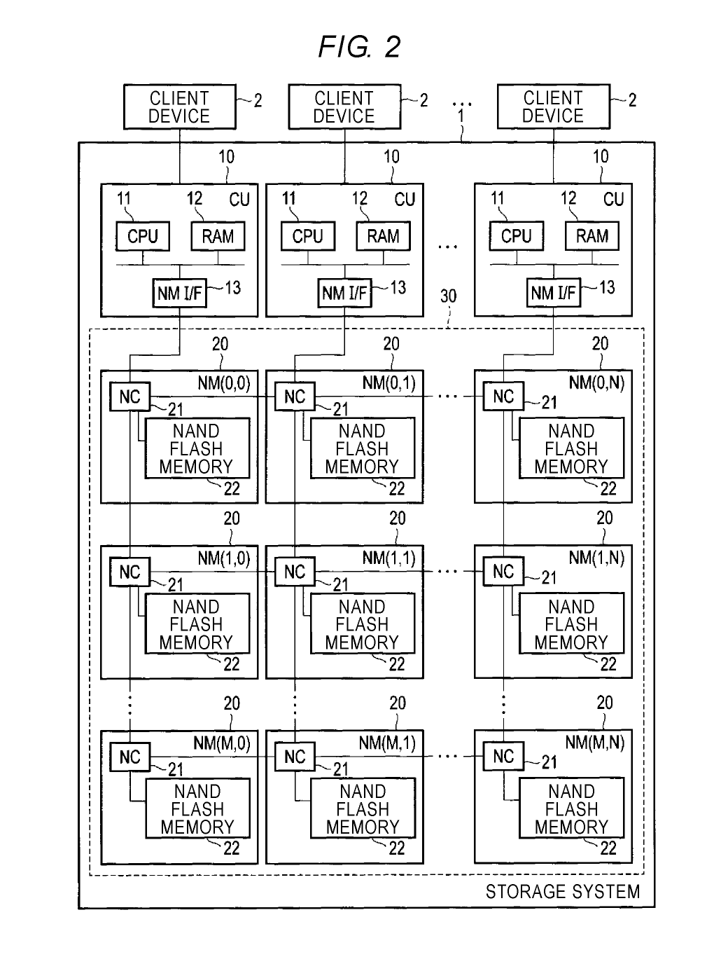

FIG. 2 is a diagram illustrating one example configuration of the storage system 1.

As illustrated in FIG. 2, the storage system 1 includes a plurality of connection units (CUs) 10 and a plurality of node modules (NMs) 20. Further, in FIG. 1, the NAND flash memory 22 illustrated to be mounted on the board unit 1002 is mounted on the NM 20 side.

The NM 20 includes a node controller (NC) 21 and one or more NAND flash memories 22. The NAND flash memory 22 is, for example, an embedded multimedia card (eMMC®). The NC 21 executes access control to the NAND flash memory 22 and transmission control of data. The NC 21 has, for example, 4 lines of input/output ports. The NCs 21 are connected to each other via the input/output ports to connect the NMs 20 in a matrix configuration. Connecting the NAND flash memories 22 in the storage system 1 in a matrix configuration means connecting the NMs 20 in a matrix configuration. By connecting the NMs 20 in a matrix configuration, the storage system 1 is able to provide a high-capacity data storage area 30 as described above.

The CU 10 executes input/output processing (including updating and deleting the data) of the data in/from the data storage area 30, which is constructed as described above, according to the request from the client device 2. In more detail, an input/output command of the data, which corresponds to the request from the client device 2 is issued with respect to the NM 20. Further, although not illustrated in FIGS. 1 and 2, a load balancer is installed as a front end processor (FEP) of the storage system 1. An address on the network N representing the storage system 1 is allocated to the load balancer and the client device 2 transmits various requests to the address. The load balancer that receives the request from the client device 2 relays the request to any one of the plurality of CUs 10. Further, the load balancer returns a processing result received from the CU 10 to the client device 2. The load balancer typically balances the request from the client device 2 to the plurality of CUs 10 so that loads on the CUs 10 are even, but as a technique of selecting any one of the plurality of CUs 10, various well-known techniques may be adopted. Alternatively, one of the plurality of CUs 10 may serve as the load balancer by operating as a master.

The CU 10 includes a CPU 11, a RAM 12, and an NM interface 13. Each function of the CU 10 is stored in the RAM 12 and implemented by a program executed by the CPU 11. The NM interface 13 executes communication with the NM 20, in more detail, the NC 21. The NM interface 13 is connected with the NC 21 of any one of the plurality of NMs 20. That is, the CU 10 is directly connected with any one of the plurality of NMs 20 through the NM interface 13 and indirectly connected with the other NMs 20 through the NC 21 of the NM 20. The NM 20 directly connected with the CU 10 varies for each CU 10. Further, although not illustrated in FIG. 2, the CUs 10 may also be connected with each other, and as a result, the CUs 10 may communicate with each other.

As described above, the CU 10 is directly connected with any one of the plurality of NMs 20. Therefore, even when the CU 10 issues the input/output command of the data with respect to the NMs 20 other than the directly connected NM 20, the input/output command is first transmitted to the directly connected NM 20. Thereafter, the input/output command is transmitted up to a desired NM 20 through the NC 21 of each NM 20. For example, when it is assumed that an identifier (M, N) is allocated to each NM 20 by combining a row number and a column number with respect to the NMs 20 connected in a matrix configuration, the NC 21 compares the identifier of its own NM 20 and the identifier designated as a transfer destination of the input/output command with each other, and as a result, the NC 21 may first determine whether the input/output command is addressed to its own NM 20. When the input/output command is not addressed to its own NM 20, the NC 21 may second determine to which NM 20 among the adjacent NMs 20 the input/output command is to be transmitted, based on a relationship of the identifier of its own NM 20 and the identifier designated as the transfer destination of the input/output command, in more detail, a size relationship of each of the row number and the column number. As the technique of transmitting the input/output command up to the desired NM 20, various well-known techniques may be adopted. A path to the NM 20, which is not originally selected as a transmission destination, may also be used as an auxiliary path.

Further, a result of the input/output processing according to the input/output command, that is, the result of the access to the NAND flash memory 22, by the NM 20 is also transmitted up to the CU 10, which is an issuing source of the input/output command, via several other NMs 20 by the operation of the NC 21 similarly to the transmission of the input/output command. For example, as information on the issuing source of the input/output command, the identifier of the NM 20 to which the CU 10 is directly connected is included, and as a result, the identifier may be designated as the transmission destination of the processing result.

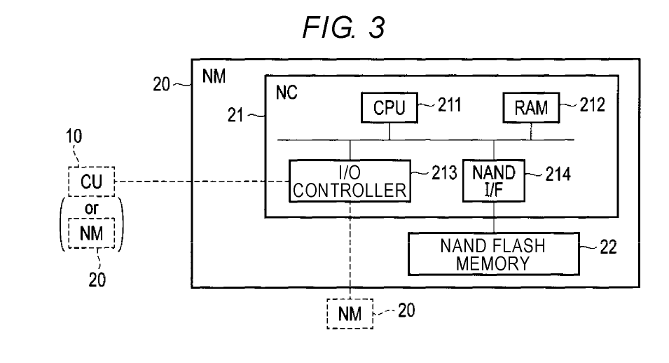

FIG. 3 is a diagram illustrating one example configuration of the NM 20.

As described above, the NM 20 includes the NC 21 and the one or more NAND flash memories 22. Further, as illustrated in FIG. 3, the NC 21 includes a CPU 211, a RAM 212, an I/O controller 213, and a NAND interface 214. Each function of the NC 21 is stored in the RAM 212 and implemented by the program executed by the CPU 211. The I/O controller 213 executes communication with the CU 10 (in more detail, the NM interface 13) or another NM 20 (in more detail, the NC 21). The NAND interface 214 executes the access to the NAND flash memory 22.

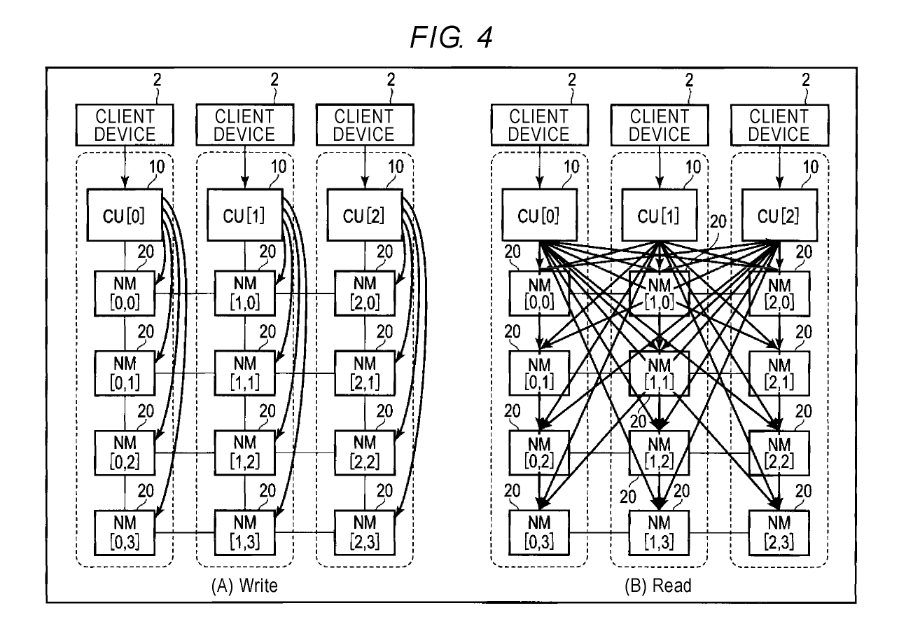

Here, referring to FIG. 4, allocation of the NM 20 to the CU 10 in the storage system 1 having the above configuration will be described.

It is assumed in this example that a predetermined CU 10 receives the writing request of the data from the client device 2. Further, it is assumed that another CU 10 also receives the writing request of the data from the client device 2 at substantially the same timing. In addition, it is assumed that these two CUs 10 select the same NM 20 as a storage destination of the key-value pair by, for example, a hash calculation using the key as a parameter or a round robin scheme. In general, in a storage device shared by a plurality of hosts (corresponding to the CUs 10), the exclusive lock is provided in order to secure data consistency and only the host which acquires the exclusive lock may execute the writing of the data. For that reason, in the above assumed case, a lock contention between the two CUs 10 occurs. The contention of the locks causes the performance of the storage device to deteriorate.

Therefore, in the storage system 1, with regard to the writing of the data, the NM 20 which may be selected as the writing destination is allocated between the CUs 10 without duplication for each CU 10 as illustrated in FIG. 4A. That is, each CU 10 may write the data only in the NM 20 allocated thereto. On the other hand, in regard to the reading of the data, each CU 10 may read the data from all of the NMs 20 as illustrated in FIG. 4B.

In regard to the writing of the data, each CU 10 just selects the storage destination of the key-value pair with respect to only the NM 20 allocated thereto. In regard to the reading of the data, each CU 10 may read the keys from all of the NMs 20 to read the data from the NM 20 storing the corresponding key, and when an index is managed, each CU 10 may specify the NM 20, which is the storage destination of the data, to read the data from the NM 20, by referring to the index.

As a result, the storage system 1 may enhance the access performance without the need for the exclusive lock.

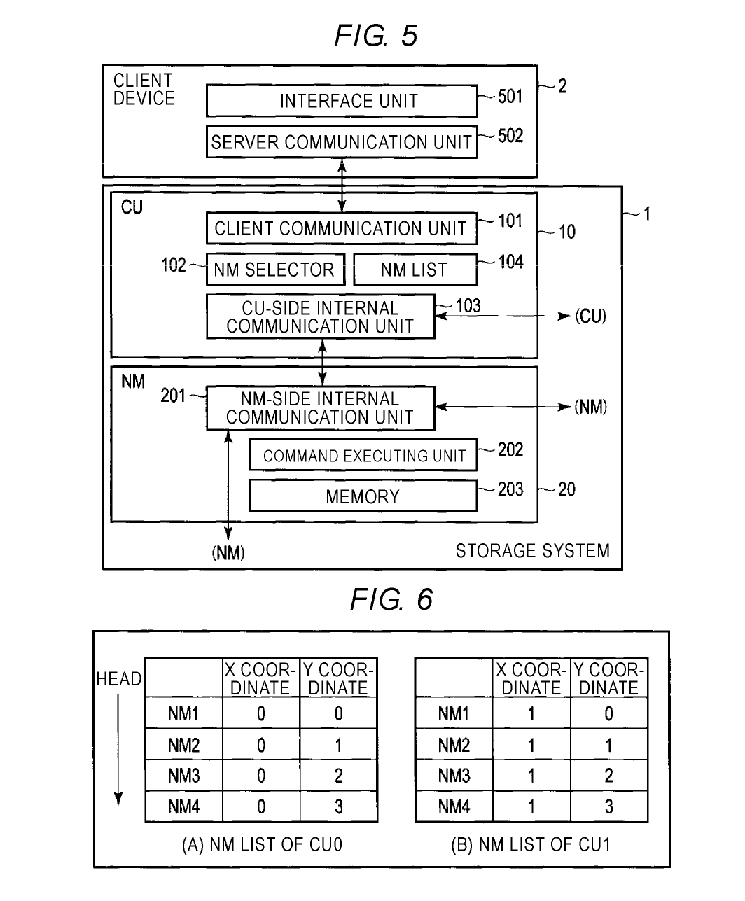

FIG. 5 is a functional block diagram of the storage system 1 according to the first embodiment.

As illustrated in FIG. 5, the CU 10 includes a client communication unit 101, an NM selector 102, a CU-side internal communication unit 103, and an NM list 104. The NM 20 includes an NM-side internal communication unit 201, a command executing unit 202, and a memory 203 (including NAND flash memory 22 and RAM 212). Each functional unit of the CU 10 is stored in the RAM 12 and implemented by the program executed by the CPU 11. Each functional unit of the NM 20 is stored in the RAM 212 and implemented by the program executed by the CPU 211. Further, the client device 2 includes an interface unit 501 and a server communication unit 502.

The interface unit 501 of the client device 2 receives requests for registration, acquisition, search, and the like of the record from a user. The server communication unit 502 executes communication with the CU 10 (through, for example, the load balancer).

The client communication unit 101 of the CU 10 executes communication with the client device 2 (through, for example, the load balancer). The NM selector 102 selects the NM 20 of the writing destination at the time of writing the data. The CU-side internal communication unit 103 executes communication with another CU 10 or NM 20. The NM list 104 is a list of the NM 20 of the writing destination allocated to each CU 10. The NM list 104 is created such that one NM 20 is prevented from being included in a plurality of NM lists 104. The NM selector 102 selects the NM 20 of the writing destination based on the NM list 104. As the technique of selecting the NM 20, various well-known techniques, such as the round robin scheme or the load balancing scheme may be adopted.

FIG. 6 illustrates one example of the NM list 104. In FIG. 6, part (A) illustrates the NM list of a CU[0] 10 when the NM 20 as the writing destination is allocated to the CU 10 as illustrated in FIG. 4, and part (B) illustrates the NM list 104 of a CU[1] 10 when the NM 20 as the writing destination is allocated to the CU 10 as illustrated in FIG. 4.

The NM-side internal communication unit 201 of the NM 20 executes communication with the CU 10 or another NM 20. The command executing unit 202 executes the access to the memory 203 according to the request from the CU 10. The memory 203 stores the data from the user. The memory 203 includes, for example, the volatile RAM 212 for temporarily storing the data in addition to the non-volatile NAND flash memory 22.

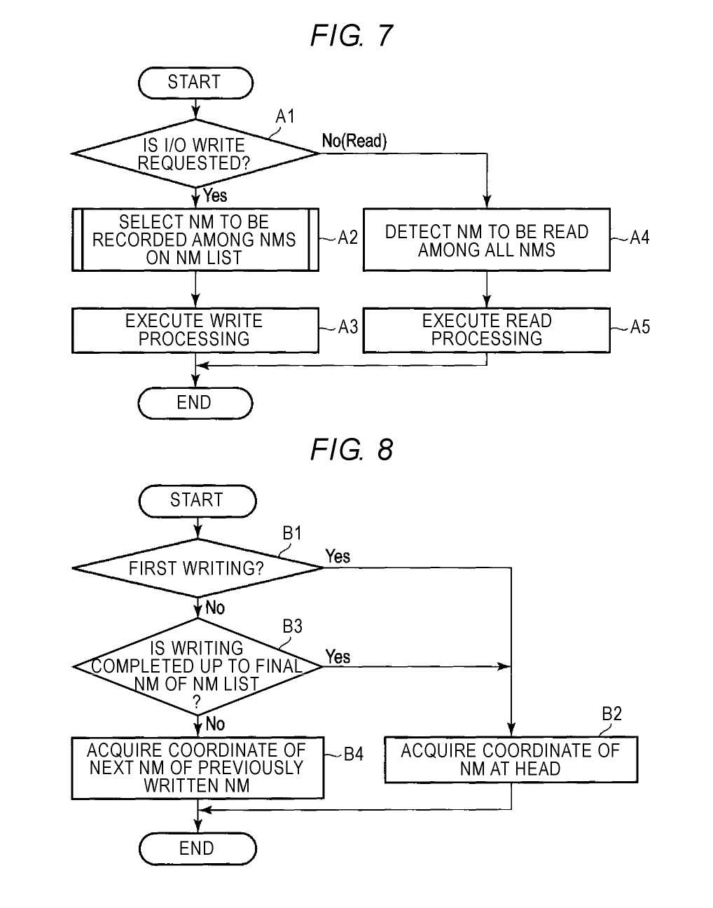

FIG. 7 is a flowchart illustrating an operation sequence of the storage system 1 according to the embodiment.

The CU 10 determines whether the request from the client device 2 is the writing of the data or the reading of the data (step A1). When the request from the client device 2 is the writing of the data (YES of step A1), the CU 10 selects a NM 20 as a writing target from among the NMs 20 on the NM list 104 (step A2). In addition, the CU 10 executes writing processing of the data with respect to the selected NM 20 (step A3).

Meanwhile, when the request from the client device 2 is the reading of the data (NO of step A1), the CU 10 selects a NM 20 as a reading target from among all of the NMs 20 (step A4). In addition, the CU 10 executes reading processing of the data with respect to the selected NM 20 (step A5).

FIG. 8 is a flowchart illustrating a detailed sequence of selection processing of the writing destination NM 20 of step A2 of FIG. 7. Herein, it is assumed that the NM 20 on the NM list 104 is selected by the round robin scheme.

First, the CU 10 determines whether the corresponding writing is first writing (step B1). When the corresponding writing is the first writing (YES of step B1), the CU 10 acquires coordinates of the NM 20 at the head of the NM list 104 from the NM list 104 (step B2).

When the corresponding writing is not the first writing (NO of step B1), the CU 10 subsequently determines whether writing is completed up to a final NM 20 on the NM list 104 (step B3). When the writing is completed up to the final NM 20 on the NM list 104 (YES of step B3), the CU 10 acquires the coordinates of the NM 20 at the head of the NM list 104 from the NM list 104 (step B2). Meanwhile, when the writing is not completed up to the final NM 20 on the NM list 104 (NO of step B3), the CU 10 acquires the coordinates of the NM 20 next to the previously written NM 20 on the NM list 104 from the NM list 104 (step B4).

As such, the storage system 1 may enhance the access performance without the need for the exclusive lock.

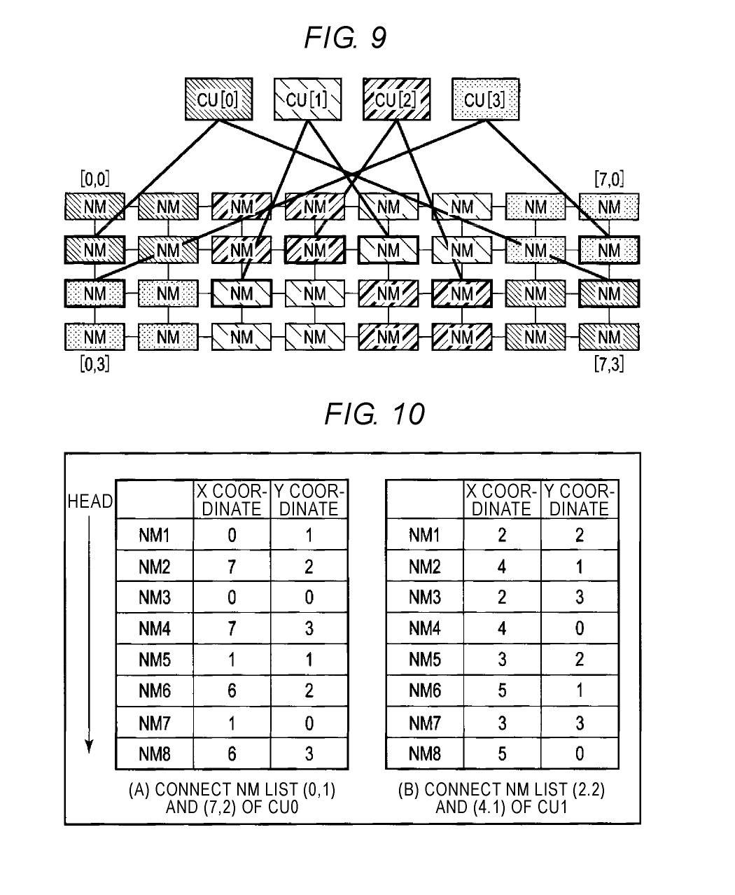

However, in the above description, it is assumed that the CU 10 is directly connected with any one of the plurality of NMs 20. As described above, the CU 10 may, for example, communicate with all of the NMs 20 with respect to the reading of the data. Further, when the CU 10 communicates with the NMs 20 other than the directly connected NM 20, one or more other NMs 20 are interposed between the CU 10 and the NM 20. Therefore, in order to enhance communication performance between the CU 10 and the NM 20, in more detail, in order to decrease the number of other NMs 20 interposed during the communication between the CU 10 and the NM 20, for example, the CU 10 may be directly connected with, for example, two NMs so as to prevent duplication between the CUs 10, as illustrated in FIG. 9. In addition, in this case, as the NM 20 of the writing destination allocated to the CU 10, the directly connected NMs 20 and the NMs 20 positioned in the vicinity of the directly connected NMs 20 on a wire may be used. Therefore, the communication performance between the CU 10 and the NM 20 at the time of writing the data may also be enhanced. FIG. 10 illustrates one example of the NM list 104 when the CU 10 and the NM 20 are connected to each other as illustrated in FIG. 9. In FIG. 10, part (A) illustrates the NM list 104 of the CU[0] 10, and part (B) illustrates the NM list 104 of the CU[1] 10.

As a result, the storage system 1 may further enhance the access performance.

### Second Embodiment

Subsequently, a second embodiment will be described. Here, the same reference numerals are used to refer to the same components as the first embodiment and the description of the same components will be omitted.

The storage system 1 according to the second embodiment is also able to provide a high-capacity data storage area by connecting the plurality of NMs 20 in a matrix. Further, the input/output processing of the data into/from the data storage area 30, which is requested from the client device 2, is executed by the plurality of CUs 10. Further, in the storage system 1 according to the embodiment, it is assumed that a column type database is constructed.

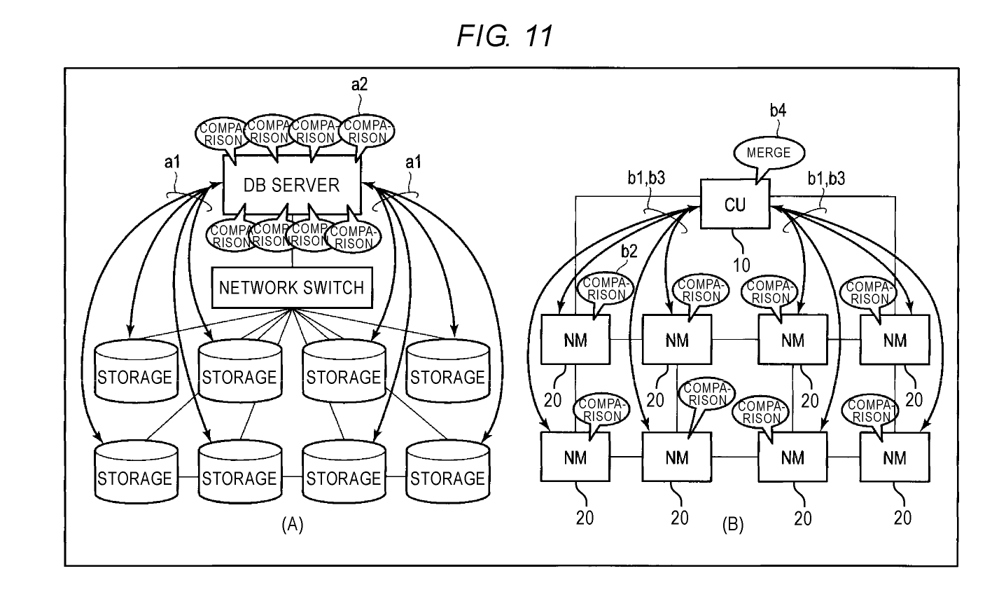

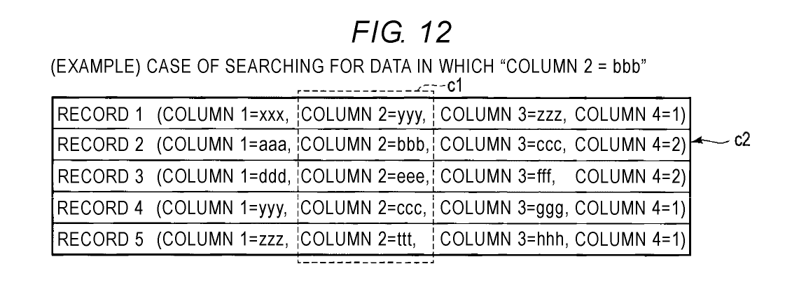

Herein, first, an outline of the storage system 1 according to the embodiment will be described with reference to FIGS. 11 and 12.

FIG. 11 is a diagram illustrating a comparison of a state where a search is performed in a general column type database (part (A) in FIG. 11) and a state where the search is performed in the storage system 1 according to the embodiment (part (B) in FIG. 11).

As illustrated in part (A) in FIG. 11, in the general column type database, for example, a DB server reads data to be searched from all storages connected through a network switch (a1) and compares each read data with a search condition (a2). Therefore, when mass data to be searched exist, an internal network connecting the DB server and the plurality of storages via the network switch is congested. Further, since mass comparisons are performed in the DB server, the load on the DB server increases. The increased load causes the performance deterioration of the column type database.

Therefore, in the storage system 1 according to the second embodiment, each NM 20 first searches data, which meet the search condition, in parallel to return only the searched data to the CU 10. In more detail, the CU 10 sends the search request to each NM 20 (b1) and each NM 20 compares the data to be searched with the search condition in each NM 20 (b2). The NM 20 in which the data which meet the search condition is searched returns the data to the CU 10 (b3), and the CU 10 merges the data returned from the NM 20 (b4).

In the storage system 1 according to the second embodiment, the amount of data on the internal network is reduced, and as a result, congestion is alleviated. Further, the search is dispersedly performed in the plurality of NMs 20 to reduce the load of the CU 10. As a result, the access performance of the storage system 1 may be enhanced.

Subsequently, the description will focus on a data storage format in the column type database. FIG. 12 is a diagram for describing waste in processing caused at the time of reading data in not the column type database but the general database.

Now, as illustrated in FIG. 12, it is assumed that five records of record 1 to record 5 exist as the data to be searched. Further, it is assumed that each record includes data of three columns of column 1 to column 4. In addition, it is assumed that the search condition in which the record in which the data of column 2 is ‘bbb’ is searched is given.

In this case, ideally, first, the data of column 2 of each record may be read (c1), and the data of the other columns in record 2, which meets the search condition (the data of column 2 is ‘bbb’), maybe read (c2). However, actually, data of a column which need not be originally read is also read.

Therefore, in the storage system 1 according to the second embodiment, secondly, the data storage format is devised to reduce the reading of data of the column which is not needed. As a result, the access performance of the storage system 1 maybe enhanced. Hereinafter, the first and second points will be described in detail.

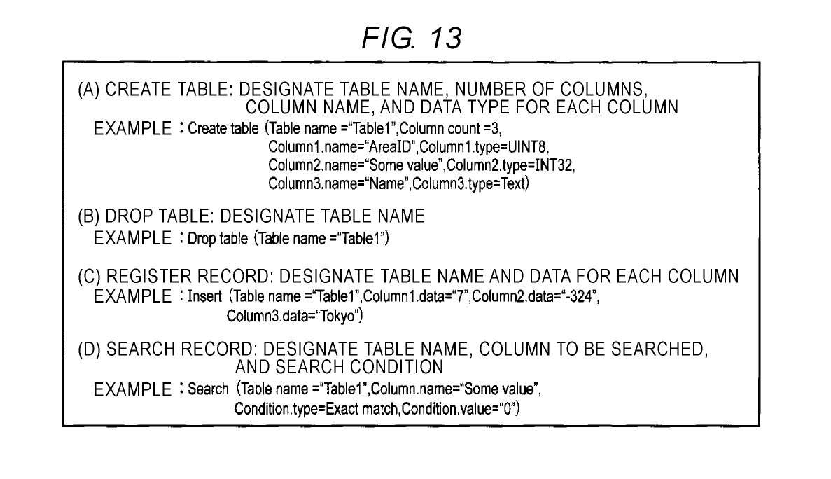

FIG. 13 is a diagram for describing an interface which the storage system 1 provides in order to operate a database.

As illustrated in FIG. 13, the storage system 1 provides at least four interfaces of table creation, table dropping, record registration, and record search for operating the column type database.

At the time of creating the table, the user of the client device 2 designates a table name, the number of columns, a column name, and a data type for each column, as illustrated in part (A) in FIG. 13. That is, the storage system 1 receives a table creation command (e.g., CreateTable) having the table name, the number of columns, the column name, and the data type for each column as the parameter.

At the time of dropping the table, the user of the client device 2 designates the table name as illustrated in part (B) in FIG. 13. That is, the storage system 1 receives a table dropping command (e.g., DropTable) having the table name as the parameter.

At the time of registering the record, the user of the client device 2 designates the table name and the data for each column as illustrated in part (C) in FIG. 13. That is, the storage system 1 receives a record registration command (e.g., Insert) having the table name and the data for each column as the parameter.

At the time of searching the record, the user of the client device 2 designates the table name, identification information of a column to be compared, and the search condition as illustrated in part (D) in FIG. 13. That is, the storage system 1 receives a record search command (e.g., Search) having the table name, identification information of the column to be compared, and the search condition as the parameter.

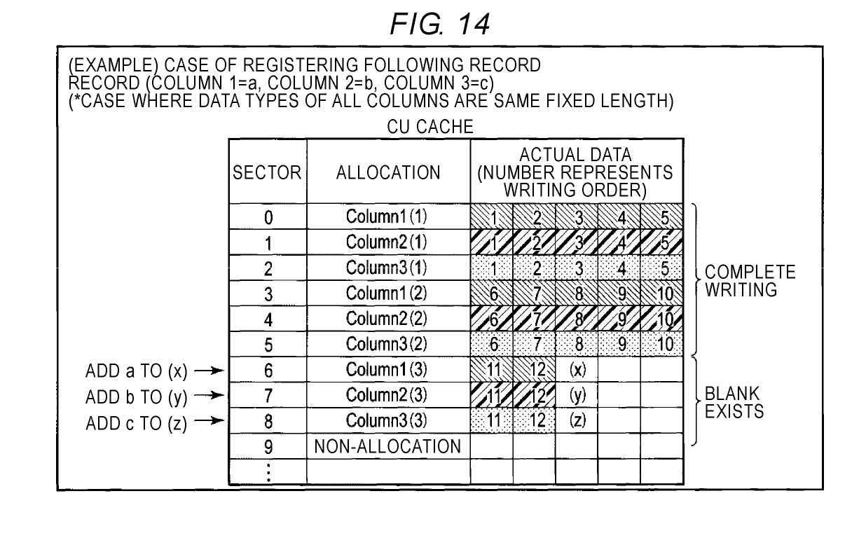

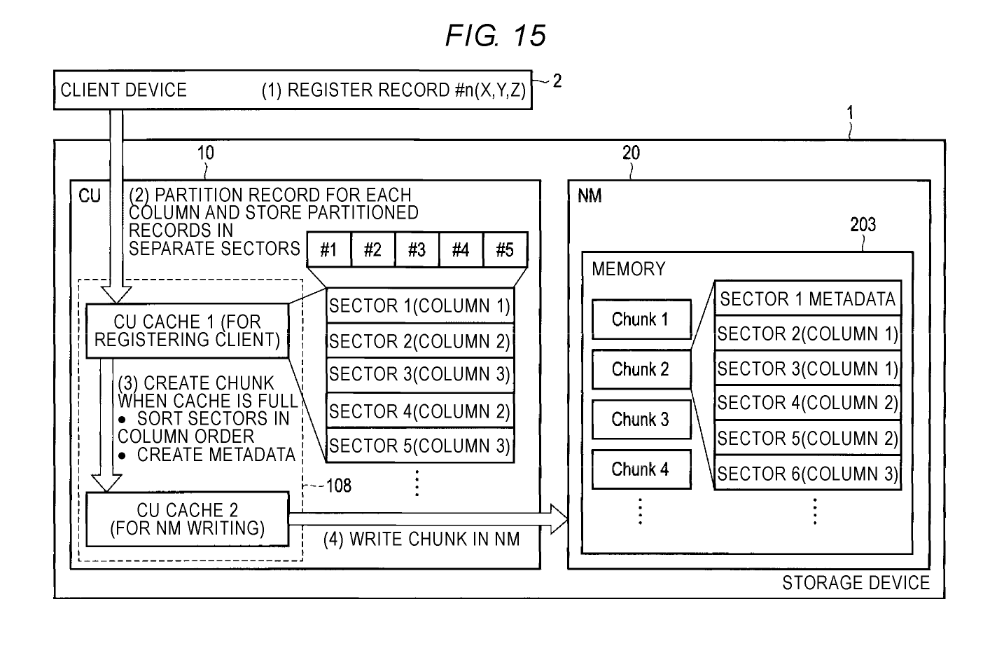

Subsequently, the operation of the storage system 1 at the time of registering the record will be described with reference to FIGS. 14 and 15.

When the record registration command illustrated in part (C) in FIG. 13 is issued, the CU 10 of the storage system 1 first stores the record (e.g., the data of each column), which is sent from the client device 2, in the cache. The cache of the CU 10 is called a CU cache. The CU cache is installed on the RAM 12. In addition, the CU 10 stores the data of each column as below while the caching. This is performed to create a chunk to be described below. The chunk is constituted by a plurality of sectors, and the cache of the CU 10 is constituted as an aggregate of sectors having the same size as the sector of the chunk. The number of sectors of the cache is the same as the number of sectors of the chunk. The size of the sector of the chunk is the same size as, for example, a page which is a reading unit of the NAND flash memory 22.

The CU 10 first partitions the record for each column. Subsequently, the CU 10 stores the data of each column after the partitioning in different sectors (on the CU cache) so that only the data of the same column is inserted into the same sector, as illustrated in FIG. 14.

FIG. 14 illustrates a case in which the record including the data of three columns is stored in the CU cache. In more detail, FIG. 14 illustrates a state in which first, the data of each column are separately stored in three sectors of sector 0 to sector 2, blanks disappear in sector 0 to sector 2, the data of each column are separately stored in three sectors of sector 3 to sector 5, the blanks disappear in sector 3 to sector 5, and the data of each column are separately stored in three sectors of sector 6 to sector 8. Further, FIG. 14 illustrates an example in which 5 data of the column are stored in each sector, but the number of data of the column, which are stored in each sector, may vary for each sector. In other words, the number of sectors used for each column may vary. When the blank disappears in a sector storing the data of a predetermined column, only the sector storing the data of the column may be newly secured, and the sector need not be secured by synchronizing the columns.

For example, when the CU cache is full, the CU 10 creates the chunk and writes the created chunk in the NM 20. Referring to FIG. 15, the creating of the chunk and the writing of the created chunk in the NM 20 will be described. Further, the creating of the chunk and the writing of the created chunk in the NM 20 may be performed at various timings including, for example, a case where a predetermined time elapses after storing first data in the CU cache (e.g., a case where a cache time of the first data exceeds the predetermined time), a case where a predetermined time elapses after storing final data in the CU cache (e.g., a case where there is no writing of the record from the client device 2 for a predetermined time), and the like, in addition to the case where the CU cache is full.

As described above, when the client device 2 registers the record (FIG. 15(1)), the CU 10 partitions the data of the record for each column and separately stores the data of each column in the sector (FIG. 15(2). In addition, when the CU cache is full, the CU 10 first creates the chunk (FIG. 15(3)).

In more detail, the CU 10 sorts the sectors in the CU cache in a column order. After the sorting of the sectors, the CU 10 generates metadata regarding each sector in the chunk and stores the generated metadata in, for example, a sector at the head of the chunk. The metadata will be described below.

When the chunk is created, the CU 10 writes data for one chunk in any one of the plurality of NMs 20 (FIG. 15(4)). As a technique of selecting any one of the plurality of NMs 20, various well-known techniques may be adopted.

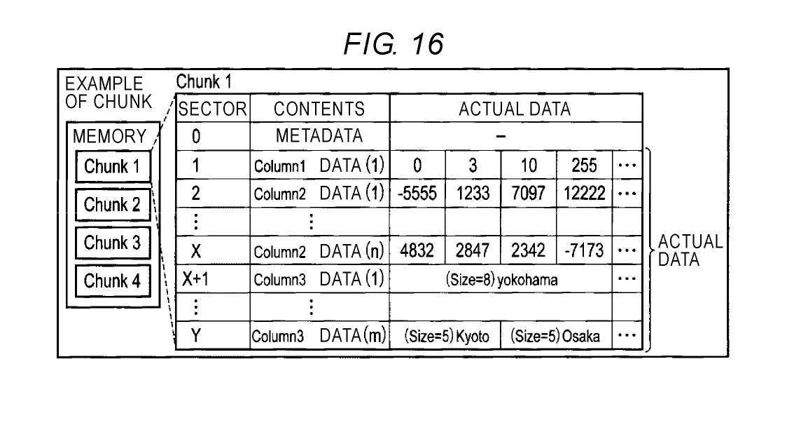

FIG. 16 is a diagram illustrating one example of a data storage format of the storage system 1 on the NM 20.

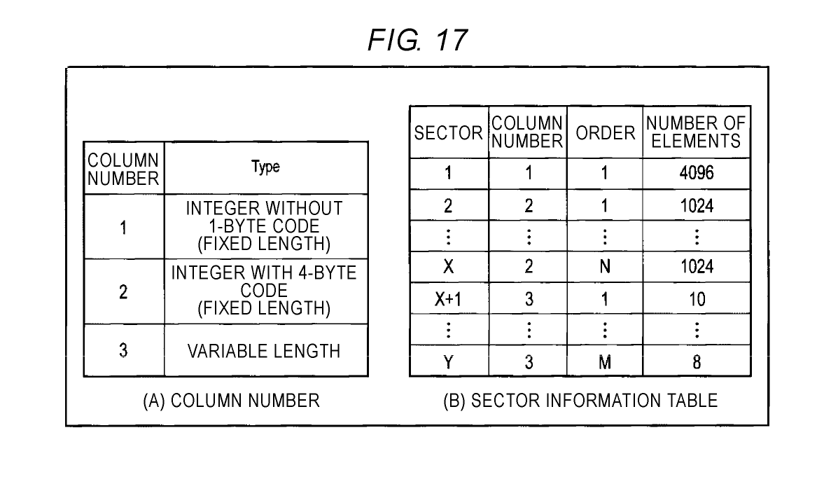

As illustrated in FIG. 16, the storage system 1 stores the data in units of the chunk. The chunk is constituted by the plurality of sectors. The sectors include two types of sectors, that is, a metadata sector and an actual data sector. The metadata sector is, for example, the sector at the head of each chunk. One example of the metadata is illustrated in FIG. 17.

As illustrated in FIG. 17, the metadata includes data type information (part (A) in FIG. 17) and a sector information table (part (B) in FIG. 17).

The data type information is information on a data type of each column. In more detail, the data type information represents a fixed length or a variable length of the data type, and when the data type is the fixed length, the data type information represents the length.

In the case of the fixed length data type, since the size may be known with the data type information, the actual data sector need not include size information of each data. Meanwhile, in the case of the variable length data type, the size information of each data is stored in the actual data sector.

Further, the sector information table is a table that stores a column number, an order, and the number of elements for each sector. The column number represents information regarding which column of data each sector stores. The order represents the order of sectors storing the same column. The number of elements represents the number of data stored by each sector.

Referring to the sector information table, it may be known in which sector the data of each column of an n-th record in the chunk is stored. In the case of the fixed length data type, an address in the sector may also be known. For example, in the case of the sector information table illustrated in FIG. 17, it may be known that data of column 2 of a 2000-th record is stored at a 976-th location of sector 3, that is, locations of 3901 bytes to 3904 bytes of sector 3.

Further, in the case of the variable length data type, the data may not be received in one sector. In this case, the plurality of sectors is used. In that case, for example, the number of elements of the sector at the head, in which the data is stored may be identified as −1, and the number of elements of the second sector may be identified as −2, and the like, by using a field of the number of elements of the sector information table.

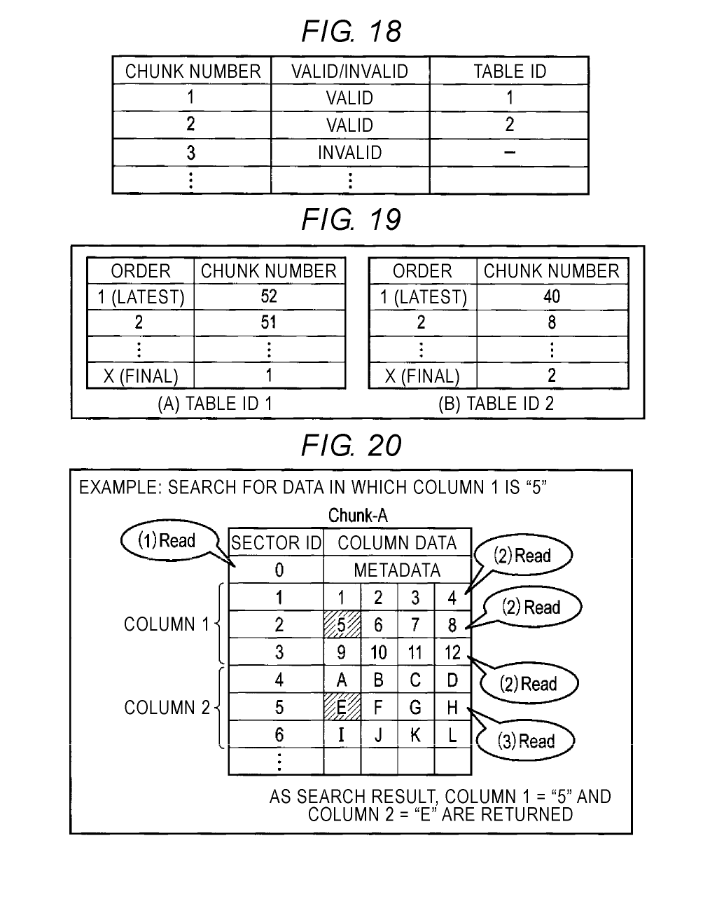

In addition, the NM 20 manages chunk management information and a chunk registration order list on the memory (e.g., RAM 212) in order to manage the chunk. FIG. 18 is a diagram illustrating one example of the chunk management information, and FIG. 19 is a diagram illustrating one example of the chunk registration order list.

The chunk management information represents information as to whether each chunk area is valid or invalid as illustrated in FIG. 18, and in regard to the valid chunk area, the chunk management information represents a table ID of the table to which the chunk area is allocated. The chunk area is an area for the chunk secured on the NM 20.

The chunk registration order list stores the registration order of the chunk for each table as illustrated in FIG. 19.

The NM 20 that manages the chunk management information and the chunk registration order list searches the invalid chunk area by the chunk management information at the time of writing the chunk. The NM 20 writes the chunk in the searched chunk area. In this case, the NM 20 updates the chunk management information in order to make the chunk area be valid and to register the table ID. Further, the NM 20 executes an update for registering a chunk number of the valid chunk area at the head with respect to the chunk registration order list of the table.

For example, when searching the record in a predetermined table is required, the NM 20 may recognize the chunk to be searched by referring to the chunk registration order list of the table. Further, for example, it is possible to search the chunk according to the order of new data or the order of old data by finding the chunk from the head or an end of the chunk registration order list.

Further, at the time of dropping the table, the NM 20 makes the chunk area, to which a table ID to be dropped is allocated in the chunk management information, be invalid, and empties the chunk registration order list of the table.

Herein, referring to FIG. 20, the operation of the NM 20 at the time of searching the record will be described.

The NM 20 repeats the following operation with respect to each chunk while finding the chunk registration order list.

The NM 20 reads the metadata from the sector at the head of each chunk ((1) in FIG. 20). Subsequently, the NM 20 reads the data from the sector in which the data of the column to be compared is stored, based on the metadata ((2) in FIG. 20). When the data, which meets the search condition, is searched, the NM 20 reads the data from the sector in which the data of another column is stored, based on the metadata ((3) in FIG. 20).

For example, as for the case of the chunk illustrated in FIG. 20, when the record in which column 1 is 5 is searched, the NM 20 reads the metadata from sector 0 and reads the data from sectors 1 to 3 storing column 1 based on the metadata. Herein, since 5-th data of column 1 meets the search condition, the NM 20 determines in which sector the 5-th data of column 2 is stored, based on the metadata. Herein, the NM 20 determines that the 5-th data is stored at a first location of sector 5. Therefore, the NM 20 reads the data from sector 5. Further, at the time of searching the record, the CU 10 also searches the data, which meets the search condition, in regard to the data on the CU cache.

As such, the storage system 1 may only read the necessary minimum number of sectors by devising the data storage format to enhance the access performance of the storage system 1. Further, the NM 10 executes the search in parallel to further enhance the access performance of the storage system 1.

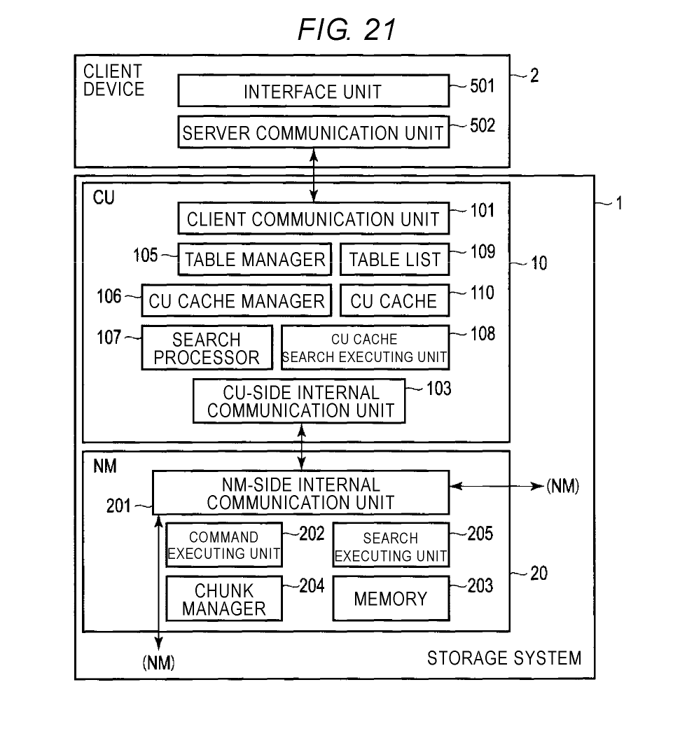

FIG. 21 is a functional block diagram of the storage system 1 according to the second embodiment.

As illustrated in FIG. 21, the CU 10 includes a client communication unit 101, a CU-side internal communication unit 103, a table manager 105, a CU cache manager 106, a search processor 107, a CU cache search executing unit 108, a table list 109, and a CU cache 110. The NM 20 includes an NM-side internal communication unit 201, a command executing unit 202, a memory 203, a chunk manager 204, and a search executing unit 205. Each functional unit of the CU 10 is stored in the RAM 12 and implemented by the program executed by the CPU 11. Each functional unit of the NM 20 is stored in the RAM 212 and implemented by the program executed by the CPU 211. Further, the client device 2 includes an interface unit 501 and a server communication unit 502.

The interface unit 501 of the client device 2 receives the requests for the registration, acquisition, search, and the like of the record from the user similarly to the first embodiment. Further, herein, since it is assumed that the column type database is constructed, the interface unit 501 additionally receives the requests for creating and dropping the table. Since the server communication unit 502 is the same as that of the first embodiment, the description thereof will be omitted.

Since the client communication unit 101 and the CU-side internal communication unit 103 of the CU 10 are the same as those of the first embodiment, the description thereof will be omitted. The table manager 105 manages information of the table created by the request from the client device 2, that is, the table list 109 to be described below. Further, the table manager 105 requests the NM 20 to perform processing of the chunk management information and the chunk registration order list stored in the table as necessary. The table list 109 includes a name of each table or information on the column. The CU cache manager 106 executes writing of data in the CU cache 110 and reading of the data from the CU cache 110. The CU cache manager 106 executes writing of data for one chunk in the NM 20, for example, in a case where a predetermined amount of data is accumulated in the CU cache 110, and the like.

The CU cache 110 is an area that temporarily stores the predetermined amount of data. The search processor 107 requests each NM 20 to perform the search. Further, the search processor 107 merges the search results from the respective NMs 20 to create a final result. The CU cache search executing unit 108 reads the record from the CU cache 110, compares the read record with the search condition, and acquires the record which meets the search condition.

Since the NM-side internal communication unit 201, the command executing unit 202, and the memory 203 of the NM 20 are the same as those of the first embodiment, the description thereof will be omitted. The chunk manager 204 manages the chunk management information and the chunk registration order list. The search executing unit 205 reads data of a column to be compared from the memory 203, compares the read data with the search condition, acquires the record which meets the search condition, and returns the acquired record to the CU 10.

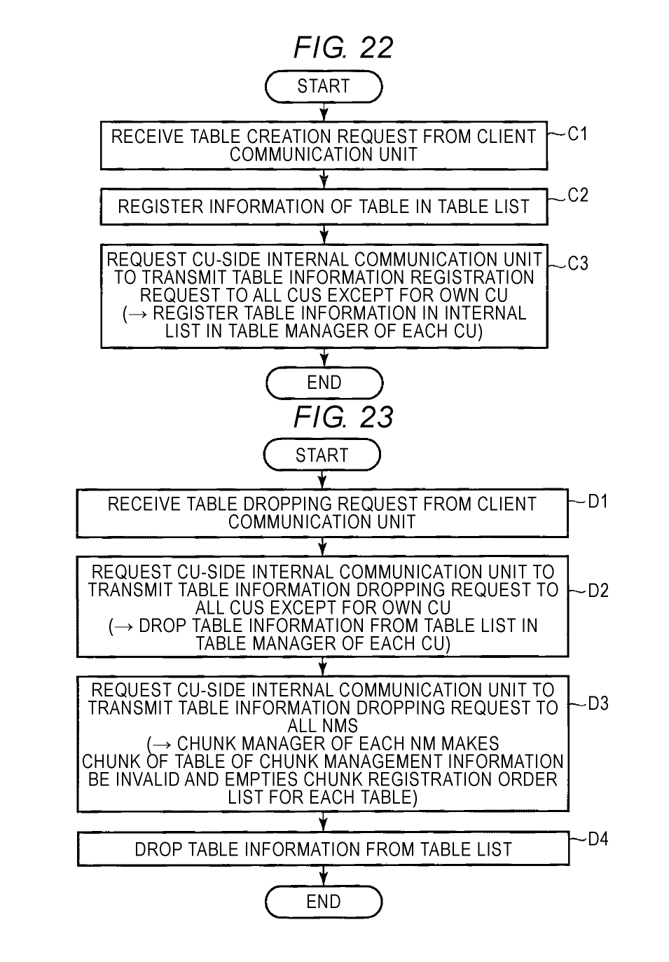

FIG. 22 is a flowchart illustrating an operation sequence of the table manager 105 of the CU 10 at the time of creating a table in the storage system 1.

When the table manager 105 receives a table creation request from the client communication unit 101 (step C1), the table manager 105 registers table information of the requested table in the table list 109 (step C2). Further, the table manager 105 requests the CU-side internal communication unit 103 to transmit a table information registration request to all of the CUs 10 except for its own CU 10 (step C3). In each CU 10, the table information is registered in the table list 109 by the table manager 105.

FIG. 23 is a flowchart illustrating an operation sequence of the table manager 105 of the CU 10 at the time of dropping a table in the storage system 1.

When the table manager 105 receives a table dropping request from the client communication unit 101 (step D1), the table manager 105 requests the CU-side internal communication unit 103 to transmit a table information dropping request from all of the CUs 10 except for its own CU 10 (step D2). In each CU 10, the table information is dropped from the table list 109 by the table manager 105.

Further, the table manager 105 requests the CU-side internal communication unit 103 to transmit the table information dropping request to all of the NMs 20 (step D3). In each NM 20, the chunk of the table becomes invalid by the chunk manager 204, and the chunk registration order list of the table is emptied by the chunk manager 204.

In addition, the table manager 105 drops the table information from the table list 109 (step D4).

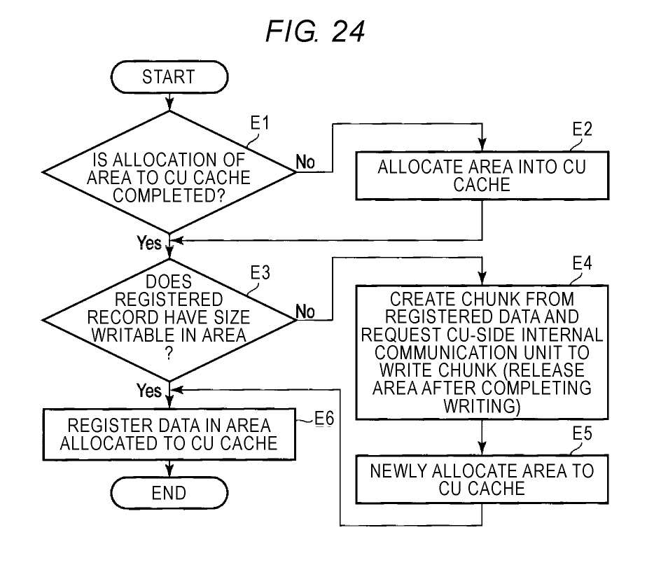

FIG. 24 is a flowchart illustrating an operation sequence of the CU cache manager 106 of the CU 10 at the time of registering the record in the storage system 1.

The CU cache manager 106 determines whether allocating the area into the CU cache 110 is completed (step E1). When the allocation is not completed (NO of step E1), the CU cache manager 106 performs area allocation in the CU cache 110 (step E2).

The CU cache manager 106 determines whether the record to be registered has a size which is writable in the area (step E3). When the record to be registered does not have the writable size (NO of step E3), the CU cache manager 106 creates the chunk from registered data and requests the CU-side internal communication unit 103 to write the created chunk (step E4). When the writing is completed, the CU cache manager 106 releases the area. Subsequently, the CU cache manager 106 performs allocation of a new area in the CU cache 110 (step E5).

In addition, the CU cache manager 106 registers data in the area allocated to the CU cache 110 (step E6).

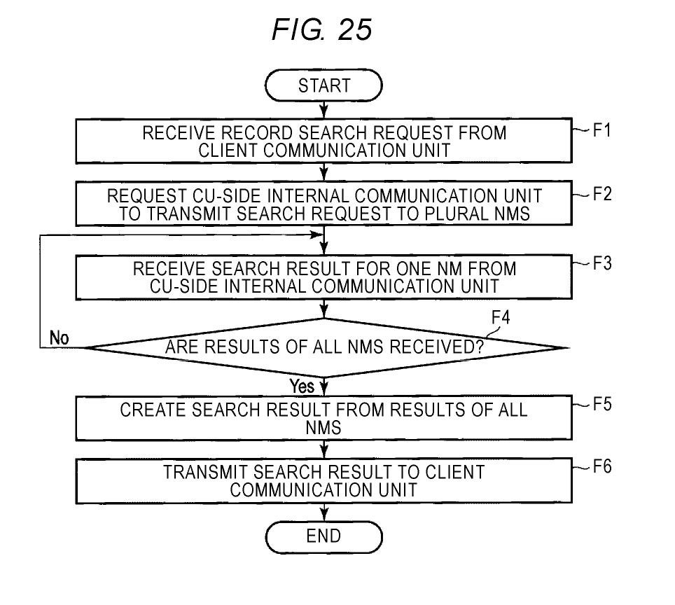

FIG. 25 is a flowchart illustrating an operation sequence of the search processor 107 of the CU 10 at the time of searching the record in the storage system 1.

When the search processor 107 receives the record search request from the client communication unit 101 (step F1), the search processor 107 requests the CU-side internal communication unit 103 to transmit the search request to the plurality of NMs 20 (step F2). The search processor 107 receives the search result for one NM 20 from the CU-side internal communication unit 103 (step F3) until the search processor 107 receives the search results of all of the NMs 20 (YES of F4), the search processor 107 creates the search result returned to the client device 2 from the search results of all of the NMs 20 (step F5). The search processor 107 transmits the created search result to the client communication unit 101 (step F6). The search result is returned to the client device 2 by the client communication unit 101.

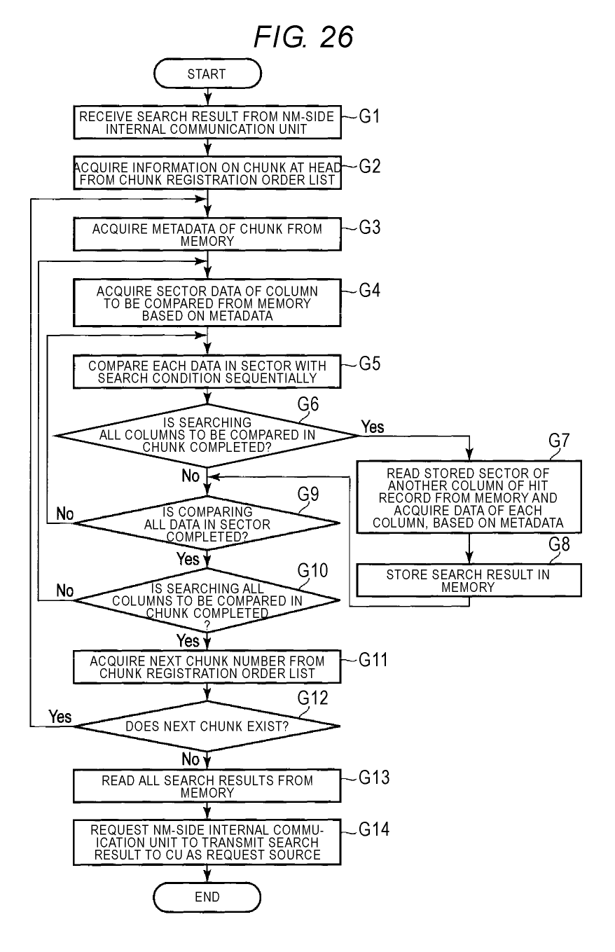

FIG. 26 is a flowchart illustrating an operation sequence of the search executing unit 205 of the NM 20 at the time of searching the record in the storage system 1.

When the search executing unit 205 receives the search request from the NM-side internal communication unit 201 (step G1), the search executing unit 205 acquires information on the chunk at the head from the chunk registration order list (step G2). Subsequently, the search executing unit 205 acquires the metadata of the chunk from the memory 203 (step G3). The search executing unit 205 acquires sector data of the column to be compared from the memory 203 based on the metadata (step G4) to compare the respective data in the sector with the search condition sequentially (step G5).

When each data meets the search condition (YES of step G6), the search executing unit 205 acquires data of another column of the record, in which the data of the column to be compared meets the search condition, from the memory 203 based on the metadata (step G7). The search executing unit 205 stores the search result in the memory 203 (step G8).

The search executing unit 205 determines whether comparing all data in the sector is completed (step G9), and if comparing all of the data is not completed (NO of step G9), the search executing unit 205 returns to step G5 to process next data in the sector. Meanwhile, when comparing all of the data is completed (YES of step G9), the search executing unit 205 subsequently determines whether searching all columns to be compared in the chunk is completed (step G10). When searching all of the columns is not completed (NO of step G10), the search executing unit 205 returns to step G4 to process a next sector in the chunk.

When searching all of the columns is completed (YES of step G10), the search executing unit 205 acquires next chunk information from the chunk registration order list (step G11). When the next chunk information exists (YES of step G12), the search executing unit 205 returns to step G3 to process a next chunk. Meanwhile, when the next chunk information does not exist (NO of step G12), the search executing unit 205 reads all search results from the memory 203 (step G13), and then, requests the NM-side internal communication unit 201 to transmit the search result to the CU 10 as a request source (step G14).

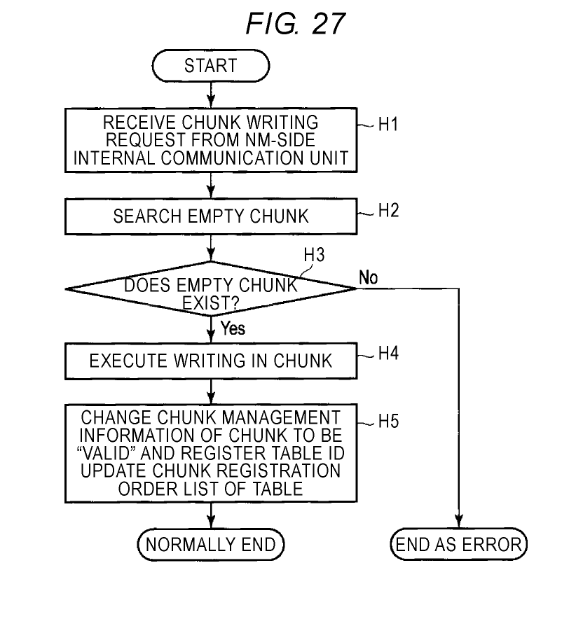

FIG. 27 is a flowchart illustrating an operation sequence of the chunk manager 204 of the NM 20 at the time of writing a chunk in the storage system 1.

When the chunk manager 204 receives the chunk writing request from the NM-side internal communication unit 201 (step H1), the chunk manager 204 searches an empty chunk (step H2). When the empty chunk does not exist (NO of step H3), the chunk manager 204 terminates processing of the requested chunk writing as an error.

When the empty chunk exists (YES of step H3), the chunk manager 204 executes writing in the chunk (step H4). The chunk manager 204 changes the chunk management information of the chunk to be valid to register the table ID and update the chunk registration order list of the corresponding table (step H5).

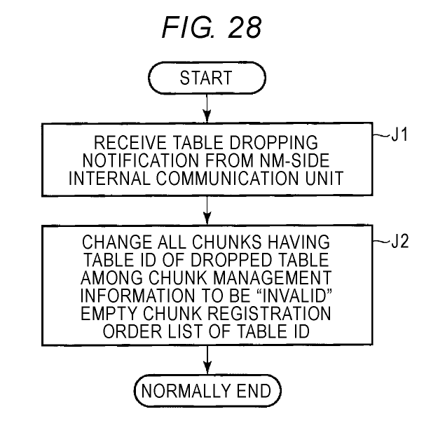

FIG. 28 is a flowchart illustrating an operation sequence of the chunk manager 204 of the NM 20 at the time of dropping the table in the storage system 1.

When the chunk manager 204 receives a table dropping notification from the NM-side internal communication unit 201 (step J1), the chunk manager 204 changes all of the chunks having the table ID of the dropped table to be invalid among the chunk management information and empties the chunk registration order list of the table ID of the dropped table (step J2).

As described above, in the storage system 1, each NM 20 first searches the data, which meets the search condition, in parallel, and second devises the data storage format to enhance the access performance.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein maybe made without departing from the spirit of the inventions. The accompanying claims and their equivalents are intended to cover such forms or modifications as would fall within the scope and spirit of the inventions.

What is claimed is:

1. A storage system comprising:
a plurality of storage nodes, each including a local processor and one or more non-volatile memory devices;
a first control node having a first processor and directly connected to a first storage node; and
a second control node having a second processor and directly connected to a second storage node, wherein
the local processor of a node controls access to the non-volatile memory devices of said node and processes read and write commands issued from the first and second processors that are targeted for said node, and
each of the first and second processors is configured to issue read commands to any of the storage nodes, and issue write commands only to a group of storage nodes allocated thereto, such that none of the storage nodes can be targeted by both the first and second processors.

2. The storage system according to claim 1, wherein
the storage nodes are connected in a matrix configuration, and
first and second groups of storage nodes are allocated to the first and second processors, respectively, the first group including the first storage node and the second group including the storage node.

3. The storage system according to claim 2, wherein the first group further includes a third storage node that is directly connected to the first control node and the second group further includes a fourth storage node that is directly connected to the second control node.

4. The storage system according to claim 3, wherein
additional storage nodes in the first group are directly connected to one of the first and third storage nodes, and
additional storage nodes in the second group are directly connected to one of the second and fourth storage nodes.

5. The storage system according to claim 4, wherein a storage node does not belong to both the first and second groups.

6. The storage system according to claim 2, wherein
additional storage nodes in the first group are directly connected to the first storage node, and
additional storage nodes in the second group are directly connected to the second storage node.

7. The storage system according to claim 6, wherein a storage node does not belong to both the first and second groups.

8. The storage system according to claim 1, wherein
the first processor, when issuing write commands, selects one of the storage nodes in the first group according to a round robin scheme, and
the second processor, when issuing write commands, selects one of the storage nodes in the second group according to the round robin scheme.

9. The storage system according to claim 2, wherein
the first control node includes a local memory in which a list of storage nodes identifying the storage nodes in the first group is stored, and
the second control node includes a local memory in which a list of storage nodes identifying the storage nodes in the second group is stored.

10. A method of controlling write operations in a storage system including a plurality of storage nodes, each including a local processor and one or more non-volatile memory devices, a first control node, and a second control node, wherein the local processor of a node controls access to the non-volatile memory devices of said node and processes read and write commands issued from the first and second control nodes that are targeted for said node, said method comprising:
at the first control node, responsive to a first write request, selecting a first write destination from a first group of storage nodes, and issuing a first write command to one of the storage nodes in the first group; and
at the second control node, responsive to a second write request, selecting a second write destination from a second group of storage nodes, and issuing a second write command to one of the storage nodes in the second group, wherein
no storage node belongs to both the first and second groups.

11. The method according to claim 10, wherein
the storage nodes are connected in a matrix configuration, and
the first group includes a first storage node that is directly connected to the first control node and the second group includes a second storage node that is directly connected to the second control node.

12. The method according to claim 11, wherein the first group further includes a third storage node that is directly connected to the first control node and the second group further includes a fourth storage node that is directly connected to the second control node.

13. The method according to claim 12, wherein
additional storage nodes in the first group are directly connected to one of the first and third storage nodes, and
additional storage nodes in the second group are directly connected to one of the second and fourth storage nodes.

14. The method according to claim 11, wherein
additional storage nodes in the first group are directly connected to the first storage node, and
additional storage nodes in the second group are directly connected to the second storage node.

15. The method according to claim 10, wherein
one of the storage nodes in the first group is selected according to a round robin scheme, and
one of the storage nodes in the second group is selected according to the round robin scheme.

16. The method according to claim 15, wherein
the first control node includes a local memory in which a list of storage nodes identifying the storage nodes in the first group is stored, and
the second control node includes a local memory in which a list of storage nodes identifying the storage nodes in the second group is stored.

17. A storage system comprising:
a plurality of storage nodes that are connected to each other in a matrix configuration, each of the storage nodes including a local processor and one or more non-volatile memory devices;
a first control node for a first column of the storage nodes, the first control node having a first processor and directly connected to a first storage node, which is in the first column; and
a second control node for a second column of the storage nodes, the second control node having a second processor and directly connected to a second storage node, which is in the second column, wherein
the first processor is prevented from issuing write commands to the second storage node and the second processor is prevented from issuing write commands to the first storage node.

18. The storage system according to claim 17, wherein the first processor is prevented from issuing write commands to any of the storage nodes in the second column and the second processor is prevented from issuing write commands to any of the storage nodes in the first column.

19. The storage system according to claim 17, wherein
the first control node includes a local memory in which a first list of storage nodes is stored, the first list identifying the storage nodes that the first processor is permitted to target as a write destination, and
the second control node includes a local memory in which a second list of storage nodes is stored, the second list identifying the storage nodes that the second processor is permitted to target as a write destination.

20. The storage system according to claim 19, wherein the first storage node is identified in the first list and the second storage node is identified in the second list, and there are no storage nodes identified in both the first list and the second list.
